(19) United States
(12) Patent Application Publication
(10) Pub. No.: US 2007/0162747 A1
(43) Pub. Date: Jul. 12, 2007

(54) SYSTEM AND METHOD FOR ENCRYPTING DATA FILES

(75) Inventors: BOR-CHUAN LIN, Tu-Cheng (TW); GAO-PENG HU, Shenzhen (CN); CAI-YANG LUO, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/611,136

(22) Filed: Dec. 15, 2006

(30) Foreign Application Priority Data
Jan. 12, 2006 (CN) 200610032911.8

(51) Int. Cl. H04L 9/32; H04L 9/00; G06F 12/14; G06F 17/30; G06F 7/04; G06F 11/30; G06K 9/00; H03M 1/68; H04K 1/00; H04N 7/16

(52) U.S. Cl. 713/165; 713/189; 713/167; 726/27

(57) ABSTRACT

An exemplary method for encrypting data files automatically is provided. The method includes: reading a configuration file, the configuration file comprising configuration information that comprises a name and a data path of a data file directory and data formats of data files to be encrypted; monitoring whether there is a new data file been newly added into the data file directory; detecting whether data format of the new data file is one of the data formats as set forth in the configuration file; detecting whether the new data file has an encryption mark if the data format of the new data file is one of the data formats; generating corresponding encryption details if the new data file does not have an encryption mark; and encrypting the new data file according to the encryption details. A related system is also provided.

### BACKGROUND OF THE INVENTION

1. Field of the Invention

The present invention relates to a system and method for encrypting data files.

2. Description of Related Art

The Internet has made it possible to transfer data between two remote locations. The data are usually sent from a sender's terminal that is directly connected to the Internet or indirectly thru an intranet. The recipient is usually another computer terminal, but not limited to fax machines, printers, and such connected to the Internet. All these data transfers have given rise to the development of security systems to protect and ensure data sent over the Internet remain safe, secured, and untampered with.

Digital rights management (DRM) and enforcement is highly desirable when it comes to distributing digital content. The digital content consists digital audio, digital video, digital text, digital data, digital multimedia, etc. Typical modes of distribution include tangible devices such as a magnetic (floppy) disk, a magnetic tape, an optical (compact) disk (CD), etc., and intangible media such as an electronic bulletin board, an electronic network, the Internet, etc. When digital content has been received by the user, the digital content are read/executed/invoked with an appropriate rendering device such as a media player on a personal computer or the like.

In general encryption technology, an encryption system needs to be invoked to use the DRM technology to encrypt a data file. First, a user needs to login to a DRM system, and then the DRM system uses a client-side program of the encryption system to encrypt the data file. Secondly, the DRM uploads the encrypted data file to a data file server for centralized management. The DRM system cannot automatically encrypt the data file in the data server.

What is needed, therefore, is a system and method for encrypting data files in the data server automatically.

### SUMMARY OF THE INVENTION

A system for encrypting data files is provided in accordance with a preferred embodiment. The system includes a configuration file storing module, a directory monitoring module, a file format detecting module, and a file encrypting module. The configuration file storing module is configured for storing a configuration file that includes configuration information. The configuration information includes a name and data path of a data file directory and data formats of data files to be encrypted. The directory monitoring module is configured for reading the configuration information in the configuration file, monitoring whether there is a new data file been newly added into the data file directory. The file format detecting module is configured for detecting whether data format of the new data file is one of the data formats as set forth in the configuration file, detecting whether the new data file has an encryption mark if the data format of the new data file is one of the data formats as set forth in the configuration file. The file encrypting module is configured for generating encryption details corresponding to the new data file if the new data file does not have an encryption mark, and encrypting the new data file according to the encryption details.

A method for encrypting data files is disclosed. The method includes: reading the configuration file, the configuration file including configuration information that includes the name and data path of the data file directory and data formats of data files to be encrypted; monitoring whether there is a new data file been newly added into the data file directory; detecting whether data format of the new data file is one of the data formats as set forth in the configuration file; detecting whether the new data file has an encryption mark if the data format of the new data file is one of the data formats; generating corresponding encryption details if the new data file does not have an encryption mark; and encrypting the new data file according to the encryption details.

Other systems, methods, features, and advantages of the present invention will be or become apparent to one with skill in the art upon examination of the following drawings and detailed description.

### BRIEF DESCRIPTION OF THE DRAWINGS

FIG. 1 is a schematic diagram illustrating an application environment of a system for encrypting data files in accordance with one preferred embodiment;

FIG. 2 is a schematic diagram of software function modules of the system of FIG. 1; and

FIG. 3 is a flowchart of a preferred method for encrypting data files in accordance with another embodiment.

### DETAILED DESCRIPTION OF THE INVENTION

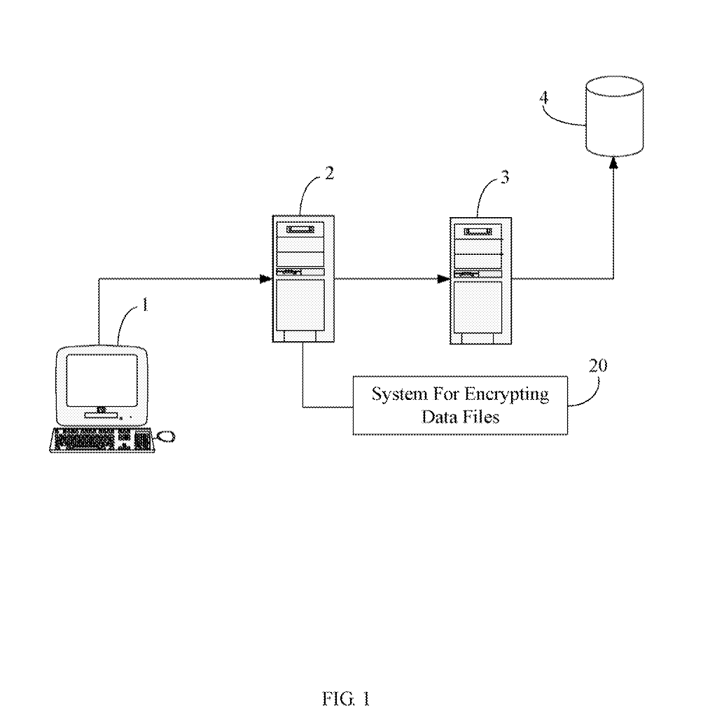

FIG. 1 is a schematic diagram illustrating an application environment of a system for encrypting data files (hereinafter, “the system 20”), in accordance with a preferred embodiment. The application environment of the system 20 typically includes a client computer 1, a data file server 2, a database server 3, and a database 4.

The client computer 1 is connected with the data file server 2, and is configured for uploading data files to the data file server 2. The system 20 is configured in the data file server 2 for receiving the data files uploaded from the client computer 1, generating encryption details of the data files, and encrypting the data files. The database 4 is connected with the database server 3, and is configured for storing the encryption details. The encryption details may include an identifier (ID) of the data file to be encrypted or decrypted, and a pair of keys. The pair of keys includes a public key and a private key. The public key is used for encrypting the data files and the private key pair is used for decrypting the data files that was encrypted using the public key pair of the private key.

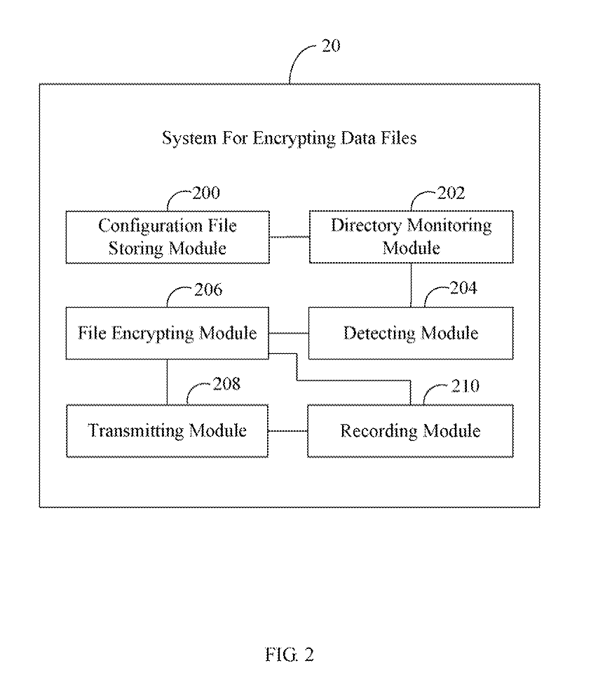

FIG. 2 is a schematic diagram of software function modules of the system 20. The system 20 typically includes a configuration file storing module 200, a directory monitoring module 202, a file format detecting module 204, a file encrypting module 206, a transmitting module 208, and a recording module 210.

The configuration file storing module 200 is configured for storing a configuration file that contains configuration information. The configuration information may include a name and a data path of a data file directory, data formats of the data files that can be encrypted, an operating system of the data file server 2, an identifier (ID) of the database server 3, and types of communication ports of the database server 3. The data file directory is configured for storing the data files to be encrypted or decrypted, temporary files, encrypted files, and decrypted files. For example, the data formats can be Microsoft Word document format, Microsoft Excel spreadsheet format, and so on. The temporary files are working files used when the system 20 encrypts or decrypts the data files. The data files are encrypted into cryptograms that are stored in the data file directory.

The directory monitoring module 202 is configured for reading the configuration information, monitoring whether there is a new data file newly added into the data file directory. The new data file can be the data file that is to be encrypted or decrypted.

The file format detecting module 204 is configured for detecting whether data format of the new data file is one of the data formats as set forth in the configuration file.

If the data format of the new data file is one of the data formats as set forth in the configuration file, the file format detecting module 204 is further configured for detecting whether the new data file has an encryption mark. The encryption mark indicates that the new data file has been encrypted. The encryption mark is an embedded data in the encrypted file. For example, the encryption mark of one encrypted file is in a text header. If the new data file does not have an encryption mark, the file encrypting module 206 generates encryption details corresponding to the new data file. The file encrypting module 206 is further configured for encrypting the new data file based on the encryption details thereby yielding an encrypted file of the new data file.

The transmitting module 208 is configured for transmitting the encryption details to the database server 3. The database server 3 is configured for storing the encryption details in the database 4. The transmitting module 208 is further configured for verifying whether the encryption details have been stored into the database 4. If the encryption details have been stored into the database 4, the file encrypting module 206 encrypts the new data file according to the encryption details. The encryption details are also used for decrypting the encrypted file.

The recording module 208 is configured for recording errors such as the encryption details are failed to be stored into the database 4 fails

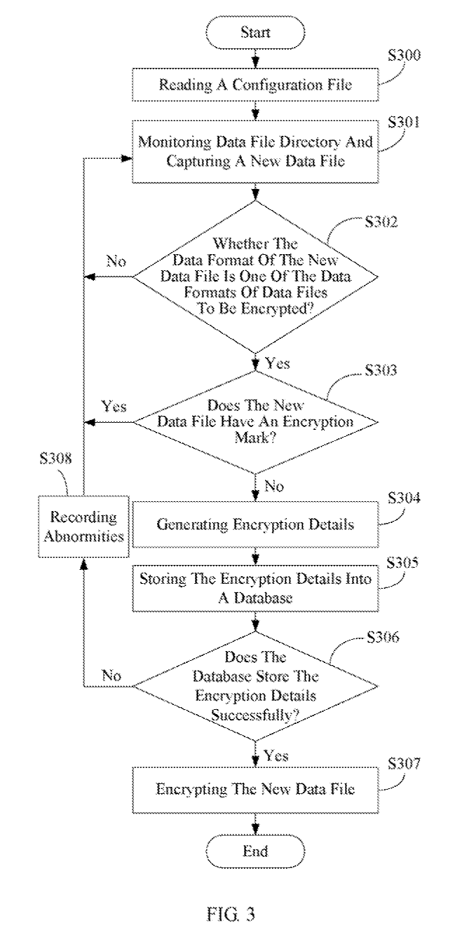

FIG. 3 is a flowchart of a preferred method for encrypting data files, in accordance with another embodiment. In step S300, the directory monitoring module 202 reads the configuration information in the configuration file. The configuration information may include the name and data path of the data file directory, the data formats of data files that can be encrypted, the application environment of the data file server 2, the ID of the database server 3, and the types of communication ports of the database server 3.

In step S301, the directory monitoring module 202 monitors whether there is the new data file newly added into the data file directory, and receives the new data file.

In step S302, the file format detecting module 204 detects whether the data format of the new data file is one of the data formats as set forth in the configuration file.

If the data format of the new data file is not one of the data formats as set forth in the configuration file, the process returns to step S301 as described above; if the data format of the new data file is one of the data formats as set forth in the configuration file, in step S303, the file encrypting module 206 detects whether the new data file has an encryption mark. The encryption mark indicates that the new data file has been encrypted, i.e., is an encrypted file.

If the new data file has the encryption mark, the process returns to step S301 as described above; if the data file does not have the encryption mark, in step S304, the file encrypting module 206 generates the encryption details of the new data file. The encryption details may include the ID of the new data file and a new pair of keys.

In step S305, the transmitting module 208 transmits the encryption details to the database server 3, and the database server 3 stores the encryption details into the database 4.

In step S306, the transmitting module 208 verifies whether the encryption details has been stored in the database 4.

If the encryption details has been stored in the database 4, in step S307, the file encrypting module 206 encrypts the new data file according to the encryption details thereby yielding the encrypted file of the new data file. If the database server 3 fails to store the encryption details into the database 4, in step S308, the recording module 210 records the error that the encryption details are failed to be stored into the database 4, and the process returns to step S301.

The above-described steps can be repeated by the system 20 in order to encrypt a plurality of new data files newly added in the data file server 2 one by one according to particular user requirements.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for encrypting data files configured in a data file server, the system comprising:
a configuration file storing module configured for storing a configuration file, the configuration file comprising configuration information that comprises a name and a data path of a data file directory and data formats of data files to be encrypted;
a directory monitoring module configured for reading the configuration information in the configuration file, monitoring whether there is a new data file been newly added into the data file directory;
a file format detecting module configured for detecting whether data format of the new data file is one of the data formats as set forth in the configuration file, detecting whether the new data file has an encryption mark if the data format of the new data file is one of the data formats as set forth in the configuration file; and
a file encrypting module configured for generating encryption details corresponding to the new data file if the new data file does not have an encryption mark, and encrypting the new data file according to the encryption details thereby yielding an encrypted file of the new data file.

2. The system according to claim 1, further comprising a transmitting module configured for transmitting the encryption details to a database server that stores the encryption details into a database.

3. The system according to claim 2, wherein the encryption details are used for decrypting the corresponding encrypted file.

4. The system according to claim 3, wherein the data file directory is configured for storing data files to be encrypted or decrypted, the data files comprising temporary files, encrypted files, and decrypted files.

5. The system according to claim 3, wherein the transmitting module is further configured for verifying whether the encryption details have been stored into the database.

6. The system according to claim 5, further comprising a recording module configured for recording errors of failing to store the encryption details into the database.

7. A method for encrypting data files configured in a data file server, the method comprising:
reading a configuration file, the configuration file comprising configuration information that comprises a name and a data path of a data file directory and data formats of data files to be encrypted;
monitoring whether there is a new data file been newly added into the data file directory;
detecting whether data format of the new data file is one of the data formats as set forth in the configuration file;
detecting whether the new data file has an encryption mark if the data format of the new data file is one of the data formats;
generating corresponding encryption details if the new data file does not have an encryption mark; and
encrypting the new data file according to the encryption details thereby yielding an encrypted file of the new data file.

8. The method according to 7, further comprising:
storing the encryption details into a database;
detecting whether the encryption details have been successfully stored in the database; and
recording error that the encryption details are failed to be stored into the database.

9. The method according to 8, further comprising:
reading the encryption details of the encrypted file from the database, and decrypting the encrypted file by utilizing the encryption details.
